(19) United States
(12) Patent Application Publication
(10) Pub. No.: US 2007/0081844 A1
(43) Pub. Date: Apr. 12, 2007

(54) Ribbon cartridge and heat transfer type image forming apparatus with the same

(75) Inventor: Yu-bin Lee, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/505,942

(22) Filed: Aug. 18, 2006

(30) Foreign Application Priority Data
Oct. 7, 2005 (KR) 2005-94515

(51) Int. Cl. B41J 17/32

(52) U.S. Cl. 400/208; 400/240.4

(57) ABSTRACT

A ribbon cartridge, comprising an ink ribbon formed of a transparent sheet with ink layers thereon, the ink ribbon including counting holes arranged at predetermined intervals in a winding direction of the ink ribbon to allow for a counting of a number of printed pages printed with the ink ribbon, and a mechanical counter having a side thereof to engage with and disengage from the counting holes while the counting holes are moved in order to count the number of printed pages.

### CROSS-REFERENCE TO RELATED APPLICATIONS

This application claims the benefit of Korean Application No. 2005-94515, filed Oct. 7, 2005, in the Korean Intellectual Property Office, the disclosure of which is incorporated herein by reference.

### BACKGROUND OF THE INVENTION

1. Field of the Invention

An aspect of the present invention relates to a heat transfer type image forming apparatus, and, more particularly, to a detection device to detect the remaining amount of ink ribbon in a heat transfer type image forming apparatus and a heat transfer type image forming apparatus having the same installed therein.

2. Description of the Related Art

A dye sublimation type heat transfer image forming apparatus uses an ink ribbon to form an image on a printing medium. Generally, the ink ribbon is accommodated in a ribbon cartridge where it is wound around a feeding reel and a winding reel. As the ink ribbon is consumed, the remaining amount of ink ribbon wound around two reels determines the number of pages to be printed. The ink ribbon is divided into a plurality of printing regions according to the printing media size. Each printing region is formed with color layer(s). The ribbon cartridge is detachably installed in the image forming apparatus. Thus, there are various kinds of ink ribbons, the variation depending on the printing media size, printing media type, dye (or pigment) used for printing, whether the ink ribbon has over coating layers or not, etc.

A selected ribbon cartridge is installed in an image forming apparatus. Before the ink ribbon in the ribbon cartridge is used up, the ribbon cartridge may be replaced with other ribbon cartridge for a different application such as when the size of printing media is changed.

Generally, ribbon cartridges have a mark, such as an optical mark, on a case thereof, and the image forming apparatus obtains information of the ribbon cartridges, such as the type and number of pages that may be printed with the ink ribbon in particular ribbon cartridges, by sensing the mark. The information stored in the mark is a constant characteristic value of the ink ribbon, which does not vary with the number of printed pages. Therefore, the image forming apparatus may detect the type of ink ribbon even when various types of ribbon cartridges are used.

However, since the ink ribbon is wound around the feeding reel and the winding reel, knowing how many more pages may be printed with the ink ribbon in the future may be difficult unless the number of previously printed pages is recorded. If the ribbon cartridge is not replaced until the ink ribbon in the ribbon cartridge is used up, the available number of printing pages (i.e., the remaining amount of ink ribbon) may be relatively easily measured by resetting the number of printed pages each time the ribbon cartridge is replaced and updating the number of printed pages in a memory each time one page is printed. However, the ribbon cartridge is usually replaced before the ink ribbon thereof is used up in order to print media of different sizes (e.g., when changing the A6 printing media with A5 printing media). In this case, the amount of remaining ink ribbon cannot be detected by storing the number of printed pages in a memory, and a printing operation is not performed. Further, the number of printing pages that may be printed may be larger than the number of available printing pages when a ribbon cartridge with an almost used up ink ribbon is installed. Therefore, there is a need for a ribbon cartridge and an image forming apparatus using the same, which prevents the above problems.

### SUMMARY OF THE INVENTION

An aspect of the present invention provides a ribbon cartridge that relatively easily detects the remaining amount of ink ribbon in a ribbon cartridge even when the ribbon cartridge is replaced and used again later, and a heat transfer type image forming apparatus with the ribbon cartridge installed therein.

According to an aspect of the present invention, there is provided a ribbon cartridge, comprising an ink ribbon formed of a transparent sheet with ink layers thereon, the ink ribbon including counting holes arranged at predetermined intervals in a winding direction of the ink ribbon to allow for a counting of a number of printed pages printed with the ink ribbon, and a mechanical counter having a side thereof to engage with and disengage from the counting holes while the counting holes are moved in order to count the number of printed pages.

The ink ribbon may further include: a plurality of printing regions; a plurality of non-printing regions provided between the printing regions to divide the printing regions; and color ink layers. The counting holes may be formed in the non-printing regions. The counting holes may be formed at side portions of the non-printing regions.

The mechanical counter may further include: a lever changing a position thereof while one end of the lever engages with and disengages from the moving counting holes; an elastic member attached to the one end of the lever to bias the lever to return the lever to an original position thereof where the lever disengages from the counting holes; and a counting unit to selectively engage with the lever, the counting unit indicating the number of printed pages while rotating on a step by step basis when the position of the lever changes and an other end of the lever does not contact the counting unit. The lever may be installed rotatably on one rotation axis.

The counting unit may include a wheel with numbers on a circumferential edge thereof, the wheel having teeth disengaging from the lever when the position of the lever changes in order to rotate the wheel step by step. The counting unit may include: a wheel having numbers on a circumferential edge to indicate the number of printed pages; and a ratchet member connected with the wheel, the ratchet member disengaging from the lever when the position of the lever changes, thereby allowing the wheel to rotate on the step by step basis. The ratchet member may be a gear. The ribbon cartridge may further include a counting window displaying the number of printed pages counted by the mechanical counter.

According to another aspect of the present invention, there is provided a heat transfer type image forming apparatus including: a ribbon cartridge including an ink ribbon formed of a transparent sheet with ink layers thereon and a mechanical counter to count the number of printed pages printed with the ribbon cartridge, the ink ribbon including counting holes arranged at predetermined intervals in a winding direction of the ink ribbon to allow for a counting of the number of printed pages, the mechanical counter having a side thereof to engage with and disengage from the counting holes to count the number of printed pages while the counting holes are moved; and a thermal printhead to apply heat to the ink ribbon in accordance with image data to transfer ink onto a printing medium.

The ink ribbon may further include: a plurality of printing regions; a plurality of non-printing regions provided between the printing regions to divide the printing regions; and color ink layers. The counting holes may be defined in the non-printing regions. The counting holes may be defined at side portions of the non-printing regions.

The mechanical counter may further include: a lever changing a position thereof while one end of the lever engages with and disengages from the moving counting holes; an elastic member attached to the one end of the lever to apply an elastic force to the lever to return the lever to an original position thereof when the lever disengages with the counting hole; and a counting unit to selectively engage with the lever, the counting unit indicating the number of printed pages while rotating on a step by step basis when the position of the lever changes and the other end of the lever does not contact the counting unit. The lever may be installed rotatably on a rotation axis.

The counting unit may include a wheel with numbers on a circumferential edge thereof, the wheel having teeth disengaging from the lever when the position of the lever changes in order to rotate the wheel on the step by step basis. The counting unit may include: a wheel having numbers on a circumferential edge to indicate the number of printed pages; and a ratchet member connected with the wheel, the ratchet member disengaging from the lever when the position of the lever changes in order to rotate the wheel step by step. The ratchet member may be a gear. The ribbon cartridge may further include a counting window displaying the number of printed pages counted by the mechanical counter.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:The above and other features and advantages of the present invention will become more apparent by describing in detail exemplary embodiments thereof with reference to the attached drawings in which:

FIG. 1 is a sectional view schematically showing a heat transfer type image forming apparatus according to an embodiment of the present invention;

FIG. 2 is a view schematically of a ribbon cartridge of the heat transfer type image forming apparatus of FIG. 1;

FIG. 3 is a view of an ink ribbon of the heat transfer type image forming apparatus of FIG. 1;

FIG. 4 is an exploded perspective view of a mechanical counter of the heat transfer type image forming apparatus of FIG. 1;

FIG. 5 is a side view of the mechanical counter depicted in FIG. 4;

FIGS. 6 and 7 are views showing an operation of the mechanical counter depicted in FIG. 4; and

FIG. 8 is a view showing a mechanical counter according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

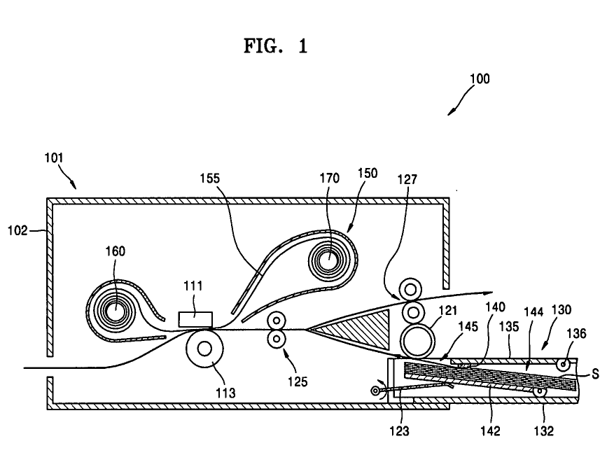

FIG. 1 is a sectional view schematically showing a heat transfer type image forming apparatus according to an embodiment of the present invention. As shown in FIG. 1, a heat transfer type image forming apparatus 100 includes a main body 101 and a media cassette 130. The main body 101 includes a ribbon cartridge 150 to print images on printing media (S) (such as paper, a transparency, etc.). The media cassette 130 is detachably attached to the main body 101. The ribbon cartridge 150 is detachably installed in a housing 102 of the main body 101, which forms the outside of the main body 101.

A pick-up roller 121, feeding rollers 125, and ejecting rollers 127 are respectively provided in the main body 101. The pick-up roller 121 picks up individual sheets of the printing media (S) (hereinafter referred to as “the printing medium (S)”) stacked in the media cassette 130. The feeding rollers 125 feed the picked-up printing medium (S) in a feeding direction to allow the printing medium (S) to pass through between a thermal printhead 111 and a platen roller 113, and, if necessary, may feed the printing medium (S) in a reverse direction to the feeding direction. After printing is completed, the ejecting rollers 127 eject the printing medium (S) to the outside of the image forming apparatus 100. The feeding rollers 125 and the ejecting rollers 127 include driving rollers that provide a driving force to feed the printing media (S) and idle rollers that are elastically engaged with the driving rollers. The printing media (S) that are ejected from the image forming apparatus 100 are stacked on a media output tray (not shown).

The thermal printhead 111 is provided in the main body 101 to form an image on the printing medium (S). To this end, the thermal printhead applies heat to an ink ribbon 155 to sublimate dye of the ink ribbon 155 onto the printing medium (S). That is, the heat transfer type image forming apparatus 100 of the present invention prints image data using a dye diffusion thermal transfer (D2T2) method. According to the D2T2 method, the thermal printhead 111 applies heat to the ink ribbon 155 coated with yellow, magenta, and cyan dyes, which are sublimated and transferred from the ink ribbon to the printing medium (S) to print image data. Special paper is used for the printing media (S), and the amount of ink sublimated and transferred depends on the amount of heat applied by the thermal printhead 111. The thermal printhead 111 includes a plurality of heating units (not shown) arranged in the width direction of the printing medium (S). The heating units selectively operate depending on image data to be printed to form an image on the printing medium (S).

The platen roller 113 is provided under the thermal head 111 to press the printing medium (S) and the ink ribbon 155 to the heating units of the thermal printhead 111.

The media cassette 130 includes a base frame 132 and a cover 135 hinged on the base frame 132. An inner space 144 is defined in the media cassette 130 to receive the printing media (S) in a stacked manner. A tray 142 is installed in the space 144 and may be lifted up to a predetermined height. The printing media (S), stacked in the inner space 144, is supported by the tray 144 at the leading end.

The cover 135 covers or uncovers a top opening 145 of the base frame 132. Therefore, a top opening 145 is enlarged by opening the cover 135 to allow for a loading of the printing media (S) in the inner space 144. On the contrary, when the cover 135 is closed, the size of the opening 145 is reduced and only the leading edges of the printing media (S) are exposed, thereby preventing the printing media (S) from being contaminated by the external dirty, dust, etc.

A cleaning member 140 is attached to an inner surface of the cover 135 to remove foreign substances such as dust from the surface of the printing medium (S). The cleaning member 140 includes a sheet formed of flannelette or felt to easily induce static electricity when the sheet is rubbed with the printing medium (S). The induced static electricity causes foreign substances attached to the printing medium (S) to move to the cleaning member 140, thereby cleaning the printing medium (S). The cleaning member 140 has a length equal to or larger than the width of the printing medium (S) to prevent the apparition of dead areas where from the foreign substances are not cleaned.

Meanwhile, a pick-up plate 123 is provided under the pick-up roller 121 of the main body 101 to press the tray 142 toward the top opening 145 when the media cassette 130 is attached to the main body 101.

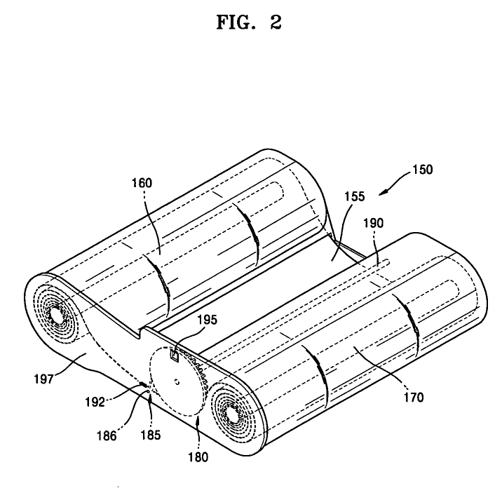

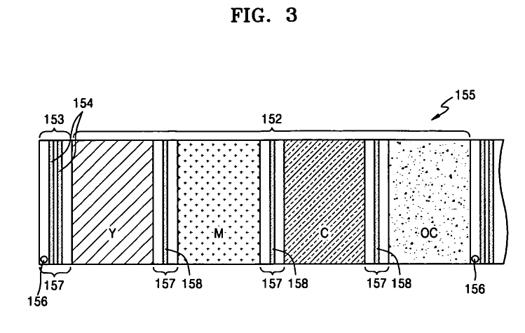

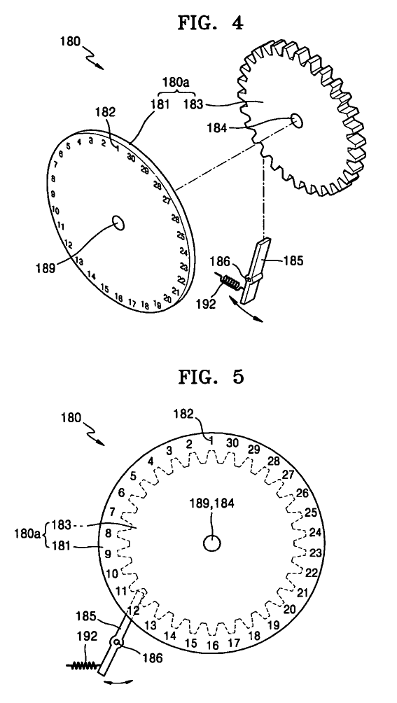

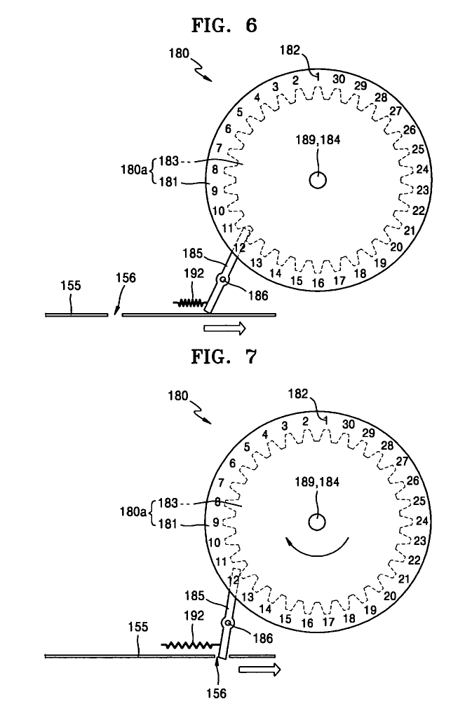

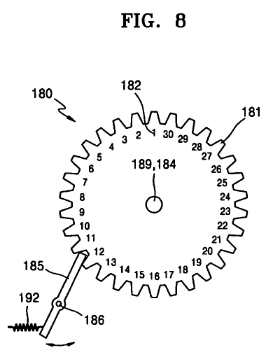

FIG. 2 is a view schematically showing a ribbon cartridge, FIG. 3 is a view of the ink ribbon 155, FIG. 4 is an exploded perspective view showing a mechanical counter, FIG. 5 is a side view of the mechanical counter depicted in FIG. 4, FIGS. 6 and 7 are views showing an operation of the mechanical counter depicted in FIG. 4, and FIG. 8 is a view showing a mechanical counter according to another embodiment of the present invention. In the drawings, like reference numerals denote like elements.

Referring to FIG. 2, the ribbon cartridge 150 includes the ink ribbon 155 containing dye to form a color on the printing medium (S) and a mechanical counter 180 to count printed pages.

As shown in FIGS. 2 and 3, the ink ribbon 155 includes a transparent sheet on which ink layers are formed, and counting holes 156 that are uniformly arranged in a winding direction to count the printed pages. One side of the mechanical counter 180 engages with and disengages from the holes 156.

The ink ribbon 155 is divided in correspondence with the length of the printing medium (S). That is, the ink ribbon 155 includes a plurality of printing regions 152 where color ink layers are formed, and non-printing regions 157 provided between the color ink layers to divide the printing regions 152.

As shown in FIG. 3, each of the printing regions 152 is divided into three printing regions Y, M, and C where Yellow, Magenta, and Cyan ink layers are formed, respectively. The printing regions Y, M, and C are divided by the non-printing regions 157, respectively. The non-printing regions 157 include donor marks 158 to indicate a starting position of the respective printing regions Y, M, and C. A non-printing region 153 is provided at the front end of the printing region 152. The non-printing region 153 includes a header mark 154 to indicate a starting position of the printing region 152. For example, to distinguish the header mark 154 from the donor marks 158, the header mark 154 may be formed in two lines and the donor marks 158 in one line. Otherwise, the header mark 154 may have a width larger than the width of the donor marks 158. Further, other various methods may be used to distinguish the header mark 154 from the donor marks 158. Meanwhile, the printing region 152 further includes an over coating region OC to coat a printed image.

When the ribbon cartridge 150 with the ink ribbon 155 having the above-mentioned configuration is installed in the image forming apparatus 100, the image forming apparatus 100 slightly winds the ink ribbon 155 until the head mark 154 is detected with an optical sensor (not shown). Then, the image forming apparatus 100 feeds the ink ribbon 155 and the printing medium (S) to allow them to pass between the platen roller 113 and the thermal printhead 111. First, the yellow printing region Y of the ink ribbon 155 overlaps with the printing medium (S), and the thermal printhead 111 applies heat to the ink ribbon 155 in accordance with yellow image data to print a yellow image on the printing medium (S). Next, the printing medium (S) is conveyed in a reverse direction or through a return passage (not shown) to feed the printing medium (S) between the thermal printhead 111 and the platen roller 113 again. At this time, the magenta region M of the ink ribbon 155 overlaps with the printing medium (S), and the thermal printhead 111 applies heat to the ink ribbon 155 in accordance with magenta image data to print a magenta image on the printing medium (S). Then, a cyan image is printed on the printing medium (S) in the same way. After the yellow, magenta, and cyan images are sequentially transferred and overlap with the printing medium (S), an overcoating layer is transferred to the printing medium (S) from the over coating region OC to increase image durability.

As shown in FIG. 2, the ink ribbon 155 is wound around a feeding reel 160 and a winding reel 170. When printing starts, a driving unit (not shown) rotates the feeding reel 160 and winding reel 170 to move the ink ribbon 155 in the feeding direction of the printing medium (S). Accordingly, the counting holes 156, which are defined in the ink ribbon 155 to count the printed pages, are also moved. In an embodiment of the invention, the counting holes 156 are defined in the non-printing regions 153 and 157, and/or in the non-printing regions 153 that are located at front ends of the printing regions 152. Further, the counting holes 156 may be defined in side portions of the non-printing regions 153 and 157 so as to not interfere with the operation of the thermal printhead 111.

Each of counting holes 156 corresponds to one printed page. Therefore, the remaining amount of the ink ribbon 155 may be determined by a counting of the number of counting holes 156 that are engaged with one side of the mechanical counter.

Referring to FIGS. 4, 5, and 2, while the counting holes 156 are moved, one side of the mechanical counter 180 is sequentially engaged with and disengaged from the counting holes 156 so as to allow for a counting of the number of printed pages. According to an embodiment of the present invention, the mechanical counter 180 includes a lever 185 operating in association with the counting holes 156, an elastic member 192 applying an elastic force to the lever 185, and a counting unit 180a indicating the number of printed pages.

When the counting holes 156 move, the position of the lever 185 changes since one end of the lever 185 is repeatedly engaged with and disengaged from the moving holes 156, and the counting unit 180a is rotated on a step by step basis. That is, when printing of a new page begins, the one end of the lever 185 is engaged with one of the counting holes 156. As the counting hole 156 moves, the position of the lever 185 changes accordingly. Thus, the other end of the lever 185, which is engaged with the counting unit 180a, is disengaged from the counting unit 180a. Thus, the counting unit 180a is rotated. Then, when the lever 185 is released from the counting hole 156, the elastic member 192 returns the lever 185 to an original position thereof.

According to an embodiment of the present invention as shown in FIGS. 4 and 5, the lever 185 rotates about an axis 186. For example, the lever 185 is hinged on a frame (not shown) of the ribbon cartridge 150. Though the lever 185 shown in the FIGS. 4 and 5 has a straight shape, the lever 185 may have other various shapes. For example, the lever 185 may be bent or may comprise a mechanical link structure depending on the structure of the counting unit 180a.

The elastic member 192 includes one end attached to the lever 185 and another end attached to the frame (not shown) of the ribbon cartridge 150, such that the elastic member 192 biases the lever 185 to return the lever 185 to an original position thereof when the position of the lever 185 changes by the counting hole 156. Elastic parts such as a spring may be used for the elastic member 192.

The counting unit 180a is synchronously engaged with and disengaged from the lever 185. When the position of the lever 185 changes, the counting unit 180a is rotated on a step by step basis while sequentially engaging with and disengaging from the lever 185. In this way, the counting unit 180a rotates on a step by step basis in accordance with the number of printed pages. In an embodiment of the invention, a driving unit or an elastic member is provided to rotate the counting unit 180a when the lever 185 is disengaged from the counting unit.

According to another embodiment of the present invention, the counting unit 180a includes a wheel 181 with numbers 182 on circumferential edges thereof to indicate individual numbers of printed pages and a ratchet member 183 that is connected to the wheel 181. When the position of the lever 185 changes, the ratchet member 183 is released from the lever 185 to allow the wheel 181 to rotate one step. Each tooth of the ratchet member 183 corresponds to a number on the wheel 181. For example, as shown in FIGS. 4 and 5, if the wheel 181 has numbers from one to thirty, the number of teeth of the ratchet member 183 should be thirty. Here, the ratchet member 183 may be formed by combining a plurality of gears.

As shown in FIGS. 4 and 5, the wheel 181 may have the numbers 182 on the circumferential edge to indicate the printed pages. Further, the wheel 181 and the ratchet member 183, respectively, have coupling holes 189 and 184 through which a shaft 190 (see FIG. 2) is inserted. As shown in FIG. 2, the wheel 181 and the ratchet member 183 are rotatably supported by the shaft 190 installed on the frame of the ribbon cartridge 150. Alternatively, though not shown, the wheel 181 and the ratchet member 183 may be rotatably attached to an inner wall of the ribbon cartridge 150.

When printing starts, as shown in FIG. 6, the ink ribbon 155 is moved in a direction illustrated by the arrow. As the ink ribbon 155 is moved in this manner, one end of the lever 185 is inserted into one of the counting holes 156. As the ink ribbon 155 is moved further, the lever 185 tends to rotate about the axis 186 and become disengaged from the tooth of the ratchet member 183. Therefore, the ratchet member 183 is rotated clockwise as indicated with the circular arrow shown in FIG. 7, such that the number “2” indicating that the second page is to be printed occupies the lever position of number “1.” Then, when the ink ribbon 155 is moved still further, the lever 185 becomes disengaged from the counting hole 156 and returned to an original position thereof due to the effect of the elastic member 192. The returned lever 185 interferes with the ratchet member 183, and, thus, the ratchet member 183 is prevented from rotating. As the printing process continues, the counting unit 180a indicates the number of printed pages while the counting unit 180a is rotated on a step by step basis.

In another embodiment of the present invention, as shown in FIG. 8, the counting unit 180a includes a wheel 181. Here, the wheel 181 is illustrated as having teeth 181a. When the position of the lever 185 changes, the lever 185 engages with and disengages from the teeth 181a such that the wheel 181 may be rotated on a step by step basis. The structure and operation of the mechanical counter 180 shown in FIG. 8 is similar to those shown in FIGS. 4 to 7. Thus, a description thereof will be omitted.

Meanwhile, referring again to FIG. 2, the ribbon cartridge 150 includes a frame 197 having a counting window 195 showing the number of printed pages counted by the mechanical counter 180. In an embodiment of the invention, the counting window 195 comprises a transparent window. Alternatively, the counting window 195 may comprise a through-hole.

Hereinafter, an operation of the heat transfer type image forming apparatus 100 will be described in detail. When a printing signal is inputted, the pick-up roller 121 picks up the printing medium (S) stacked in the media cassette 130, and the feeding rollers 125 feed the picked-up printing medium (S) to pass the printing medium (S) between the thermal printhead 111 and the platen roller 113. When the back edge of the printing medium (S) reaches the feeding rollers 125, the feeding rollers 125 stop rotating, and the thermal printhead 111 moves toward the platen roller 113 to press the ink ribbon 155 and the printing medium (S) against the platen roller 113. Then, the feeding rollers 125 rotate in a direction opposite to the feeding direction of the printing medium (S) to convey the printing medium (S) interposed between the thermal printhead 111 and the platen roller 113 to the ejecting rollers 127.

The ink ribbon 155 is moved at the same speed as the printing medium (S), and the heating units (not shown) of the thermal printhead 111 are selectively operated to sublimate the dye of the ink ribbon 155 onto the printing medium (S) to form an image on the printing medium (S). Thereafter, the ejecting rollers 127 eject the printing medium (S) to an exterior of the main body 101. As the printing operation proceeds, the counting unit 180a of the mechanical counter 180 indicates the number of printed pages that have been printed.

As is described above, the number of printed pages is indicated using the mechanical counter 180 and the counting holes 156 in the ink ribbon 155.

According to aspects of the ribbon cartridge and the heat transfer type image forming apparatus of the present invention, the mechanical counter is used to determine the amount of used or remaining ink ribbon in a different way from the prior art. Thus, the preparation or purchase of a new ribbon cartridge may be efficiently managed. Further, since the amount of used or remaining ink ribbon is indicated in a mechanical manner, the amount of used or remaining ink ribbon may be correctly indicated even when the ribbon cartridge is replaced and used again later. That is, even when various kinds of ribbon cartridges are attached and detached for printing, the remaining amount of a particular ink ribbon is not initialized, and, therefore, ribbon cartridges may be efficiently managed.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A ribbon cartridge for use with an image forming apparatus, comprising:
an ink ribbon supported by a case of the ribbon cartridge to be longitudinally depleted during a lifetime thereof due to printing operations, the ink ribbon including counting holes arranged at predetermined intervals along a longitudinal axis thereof, each counting hole representing a unit of depletion of the ink ribbon; and
a counter to engage with and disengage from the counting holes as the ink ribbon is depleted to count the units of depletion of the ink ribbon.

2. The ribbon cartridge of claim 1, wherein the ink ribbon comprises:
a plurality of printing regions;
a plurality of non-printing regions provided between the printing regions to divide the printing regions; and
color ink layers to allow for printing with different colored ink.

3. The ribbon cartridge of claim 2, wherein the counting holes are formed in the non-printing regions.

4. The ribbon cartridge of claim 3, wherein the counting holes are formed at side portions of the non-printing regions.

5. The ribbon cartridge of claim 1, wherein the counter comprises:
a lever to occupy and move between various positions thereof while an end of the lever engages with and disengages from the counting holes;
an elastic member attached to the end of the lever to bias the lever to return to an original position thereof when the lever disengages from the counting hole; and
a counting unit to selectively engage with the lever, and to thereby_indicate the units of depletion of the ink ribbon when the position of the lever changes.

6. The ribbon cartridge of claim 5, wherein the lever is installed on a rotation axis to rotate about the rotation axis.

7. The ribbon cartridge of claim 5, wherein the counting unit comprises a wheel having teeth to disengage from the lever when the position of the lever changes to allow for a rotation of the wheel.

8. The ribbon cartridge of claim 5, wherein the counting unit comprises:
a wheel to indicate the units of depletion of the ink ribbon; and
a ratchet member connected with the wheel, the ratchet member disengaging from the lever when the position of the lever changes to allow for a rotation of the wheel.

9. The ribbon cartridge of claim 8, wherein the ratchet member comprises a gear.

10. The ribbon cartridge of claim 1, further comprising a counting window to display the units of depletion of the ink ribbon.

11. A heat transfer type image forming apparatus, comprising:
a ribbon cartridge including an ink ribbon formed of a transparent sheet with ink layers thereon and a mechanical counter to count the number of printed pages printed with the ribbon cartridge, the ink ribbon including counting holes arranged at predetermined intervals in a winding direction of the ink ribbon to allow for a counting of the number of printed pages, the mechanical counter having a side thereof to engage with and disengage from the counting holes to count the number of printed pages while the counting holes are moved; and
a thermal printhead to apply heat to the ink ribbon in accordance with image data to transfer ink onto a printing medium.

12. The heat transfer type image forming apparatus of claim 11, wherein the ink ribbon further comprises:
a plurality of printing regions having lengths to correspond to a length of the printing medium;
a plurality of non-printing regions provided between the printing regions to divide the printing regions; and
color ink layers to allow for printing with different colored ink.

13. The heat transfer type image forming apparatus of claim 12, wherein the counting holes are formed in the non-printing regions.

14. The heat transfer type image forming apparatus of claim 13, wherein the counting holes are formed at side portions of the non-printing regions.

15. The heat transfer type image forming apparatus of claim 11, wherein the mechanical counter comprises:
a lever to occupy and move between various positions thereof while an end of the lever engages with and disengages from the moving counting holes;
an elastic member attached to the end of the lever to bias the lever to return to an original position thereof when the lever disengages from the counting hole; and
a counting unit to selectively engage with the lever, and to thereby indicate the number of printed pages while rotating on a step by step basis when the position of the lever changes.

16. The heat transfer type image forming apparatus of claim 15, wherein the lever is installed on a rotating axis to rotate about the rotating axis.

17. The heat transfer type image forming apparatus of claim 15, wherein the counting unit comprises a wheel with numbers on a circumferential edge thereof, the wheel having teeth disengaging from the lever when the position of the lever changes in order to rotate the wheel on the step by step basis.

18. The heat transfer type image forming apparatus of claim 15, wherein the counting unit comprises:
a wheel having numbers on a circumferential edge to indicate the number of printed pages; and
a ratchet member connected with the wheel, the ratchet member disengaging from the lever when the position of the lever changes, thereby allowing the wheel to rotate on the step by step basis.

19. The heat transfer type image forming apparatus of claim 18, wherein the ratchet member comprises a gear.

20. The heat transfer type image forming apparatus of claim 11, further comprising a counting window to display the number of printed pages counted by the mechanical counter.

21. A method of operating a ribbon cartridge of an image forming apparatus, comprising:
winding an ink ribbon held in the ribbon cartridge until a head mark thereof is detected with an optical sensor of the image forming apparatus;
feeding the ink ribbon and a printing medium being fed to the image forming apparatus to allow the ink ribbon and the printing medium to pass between a platen roller and a thermal printhead of the image forming apparatus;
printing an image onto the printing medium from a first color region of the ink ribbon;
conveying the printing medium in a reverse direction to re-feed the printing medium between the thermal printhead and the platen roller;
printing an image onto the printing medium from a second color region of the ink ribbon;
conveying the printing medium in the original feeding direction to re-feed the printing medium between the thermal printhead and the platen roller;
printing an image onto the printing medium from a third color region of the ink ribbon; and
transferring an overcoating layer to the printing medium.
